(19) United States
(12) Patent Application Publication
(10) Pub. No.: US 2018/0200897 A1
(43) Pub. Date: Jul. 19, 2018

(54) MULTI-FUNCTION STOP MECHANISM FOR FOLDING KNIFE

(71) Applicant: Spyderco, Inc., Golden, CO (US)

(72) Inventor: Paul Alexander, Ypsilanti, MI (US)

(21) Appl. No.: 15/872,213

(22) Filed: Jan. 16, 2018

Related U.S. Application Data
(60) Provisional application No. 62/446,699, filed on Jan. 16, 2017.

(51) Int. Cl. B26B 1/04

(52) U.S. Cl. CPC B26B 1/04

(57) ABSTRACT

A multi-function stop mechanism for a folding knife is provided. More specifically, the stop mechanism extends outwardly from the blade and engages a first surface of the handle when the blade is in the open position to prevent over-rotation of the blade and/or engages a second surface of the handle when the blade is in the closed position. Additionally, the outwardly extending stop mechanism may assist a user in opening the blade from the closed position to the open position.

### CROSS REFERENCE TO RELATED APPLICATIONS

This application is a claims priority from U.S. Provisional Patent Application Ser. No. 62/446,699, filed Jan. 16, 2017, entitled “Multi-Functional Stop Mechanism for Folding Knife”; the entire disclosure of which is hereby expressly incorporated by reference in its entirety.

### FIELD OF THE INVENTION

The present invention relates to cutting instruments and more specifically to folding knives with a stop mechanism to prevent over rotation of the blade in the open position and closed position and a mechanism to assist with opening the folding knives.

### BACKGROUND OF THE INVENTION

Cutting instruments have been used for centuries by craftsmen, hunters, and others requiring a sharp cutting instrument. Pocket knives are commonly carried by sportsmen, craftsmen and other users who desire a compact, portable blade which can be safely folded and transported in a pocket or attached to a belt. More recently, fixed length knives have been replaced with popular folding knives, which generally have two positions. In an open or extended position of use, the knife cutting blade is extended to expose the blade cutting edge and permit cutting therein. In a closed position, the cutting edge of the blade is stored within a cavity or recess in the handle portion of the knife, thus preventing the blade from being exposed. While folding knives are compact and portable in a closed position, a folding knife that is difficult to open presents a host of problems. Although folding knives are extremely convenient, they can potentially become dangerous if the cutting blade does not have a locking mechanism to securely keep the knife blade in the first extended position of use.

Users carry folding knives due to their compact and portable profile, but the intended use of folding knives includes emergency situations. Sportsman, craftsman, and other users are often engaged in activities that are inherently dangerous or take the user to a location that is remote from emergency services. In these situations, an emergency can arise where the user may need to immediately use his or her folding knife and time is of the essence. In an emergency, a user needs a folding knife that is quickly and easily opened from a closed position to an open position, and preferably with one hand.

Beyond emergencies, a user needs a folding knife that is quickly and easily opened from a closed position to an open position to improve the effectiveness of the folding knife and avoid injury to himself or herself. The design of a folding knife and the configuration of its components can impede the effectiveness of the folding knife.

Folding knives typically have a first scale and a second scale that form the handle portion of a folding knife. When the folding knife is in a closed position, the blade is stored within a cavity or recess created in part by the scales. If the scales are larger in height relative to the height of the blade, then a greater portion of the blade is stored in the cavity or recess and a lesser portion of the blade is exposed for a user to grip. A user has greater difficulty gripping a smaller area of the blade, and this creates difficulty when opening the blade.

An aspect of a folding knife that creates an increased risk of injury is resistance to opening. Often, folding knives have designs or configurations that create resistance to the motion of the blade to reduce the possibility that a folding knife will be unintentionally or accidentally opened. However, when a user attempts to open a folding knife with his or her fingernails, the resistance to opening can break, bend, or chip the user's fingernails or cause damage to the user's soft tissue.

Likewise, scales may interfere with the blade and create resistance. The blade pivots about a pin which also secures a first scale and a second scale to the folding knife. If the pin is short in length, the first scale and second scale may interfere with the heel end of the blade. The interference causes friction as the user opens the blade from a closed position, and thus the user must exert additional effort to open the blade.

Some existing folding knives have features that aid in opening a folding knife from a closed position. For example, some folding knives have a recess located on one side of the blade. The recess allows a user to insert his or her fingernail into the recess and pivot the blade from the closed position. However, the recess has several shortcomings. Only a fingernail may access the recess which places the fingernails under strain. Also, the recess exists only on one side of the blade. Applying force to only one side of the blade places the blade in torsion. The torsion creates a non-uniform force profile on the pin which results in increased resistance to opening. The fingernail-only access to the recess and the fact that the recess exists only on one side of the blade places a user at risk of the above-mentioned injuries associated with some folding knife designs and configurations.

U.S. Pat. No. 6,553,672 to Glesser et al. discloses a folding knife with a compression locking mechanism, and is incorporated by reference herein in its entirety. U.S. Pat. No. 6,918,184 to Glesser discloses a folding knife lock integral stop pin, and is incorporated by reference herein in its entirety. U.S. Pat. No. 6,751,868 to Glesser discloses a folding knife with a substantially spherical locking mechanism, and is incorporated by reference herein in its entirety. U.S. Pat. No. 5,615,484 to Pittman discloses a cam lock for a folding knife blade, and is incorporated by reference herein in its entirety. U.S. Pat. No. 4,985,998 to Howard discloses a folding knife with a blade lock, and is incorporated by reference herein in its entirety.

### SUMMARY OF THE INVENTION

One aspect of embodiments of the present invention is to provide a folding knife with a multi-function stop mechanism that assists in safely securing the blade in an extended position by preventing over-rotation, prevents over-rotation of the blade when the blade is in a closed position, and provides traction for the user when opening the blade to assist in opening the blade. Please note that “open” may be used herein interchangeably with “extended.”

It is thus an aspect of embodiments of the present invention to provide a folding knife that is quickly and easily openable from a closed position to an open position. It is a further aspect of embodiments of the present invention to improve the effectiveness of the folding knife, to reduce the likelihood of injury when a user rotates a folding knife blade, and to more easily overcome the resistance required to open the folding knife blade.

One aspect of embodiments of the present invention is to provide an increase in surface area or contact area for a user's thumb or fingers to decrease the concentration of forces, stress, and strain on the user when opening or closing the knife. This leads to an improved effectiveness of the folding knife and a reduced risk of injury. Some embodiments of the present invention provide opening features (also called “opening mechanisms” herein) on the blade of the folding knife to increase the surface area or contact area between the user and the blade. The improved effectiveness applies to the closing a folding knife because an increased surface area or contact area provides greater control for a user and thus less likelihood of accidentally closing the folding knife.

It is another aspect of embodiments of the present invention to provide a folding knife with a component that increases the surface area in contact with a user's thumb or index finger when using the knife in an open position. The increased surface area provides the user with greater control of the knife while using the knife.

Another aspect of embodiments of the present invention is to increase the moment force about the pivot pin to help the user overcome resistance to opening the folding knife blade. When the user moves the blade of the folding knife from a closed position to an open position, the user experiences a resistance to opening the folding knife blade. Opening features that are advantageously located on the folding knife blade help the user gain more leverage about the pivot pin to help the user overcome resistance to opening the folding knife blade.

In one embodiment of the present invention, the folding knife blade includes an aperture with a component extending from either side of the blade. For example, the extending component may assist the user in opening the folding knife blade or give the user additional control when closing the folding knife blade.

One aspect of various embodiments of the present invention is to provide a folding knife comprising a stop mechanism for preventing rotation of the blade by engagement with at least one surface of the liner or handle, thereby securing the folding knife in an extended position of use and providing improved locking features. In some embodiments, the at least one surface of the liner or handle is a vertical surface of the liner or handle. This surface may also be a forward-most portion of the handle. When the folding knife blade is in an extended position of use (also referred to herein as an “open and locked position,” “a first position,” or “a first extended position”), the stop mechanism is in a first position.

Another aspect of embodiments of the present invention is to provide a stop mechanism that prevents the blade from over rotating into the channel of the handle when in the closed position. In one embodiment, this is accomplished by the stop mechanism engaging at least one surface of the liner or handle, thereby preventing the blade from over rotating in the closed position. In some embodiments, the at least one surface of the liner or handle is a bottom surface of the liner or handle. When the folding knife is in a closed position, the stop mechanism is in a second position and is positioned against a second stop surface of the handle or liner, thereby impeding the blade from pivoting about the blade pivot point beyond the blade's closed position and creating an additional safety feature.

In some embodiments, the shape of the stop mechanism does not match the shape of the aperture. For example, the stop mechanism may be square, triangular, ovular, rectangular, an octagon, etc., and the aperture may be a circle or any other shape that does not match the stop mechanism. Alternatively, the aperture may be a circle and the aperture may be another shape, e.g., square, comet, triangular, etc. Any combination of shapes is envisioned herein. Thus, in some embodiments the shapes of the stop mechanism and aperture are concentric and in other embodiments the shapes are not concentric.

In further embodiments, the shape of the aperture may be the same as the shape of the stop mechanism, but the aperture may not sit directly in the middle of the stop mechanism such that the thickness of the stop mechanism around the aperture may vary.

In one embodiment, a folding knife is provided comprising: a handle; a blade moveable from a first extended position to a second closed position and having a front end, a tang on a rear end, a spine, a cutting edge opposite the spine, first side, and a second side opposite the first side, the blade pivotally interconnected to a forward end of the handle; a locking mechanism moveable from a first locked position to a second released position; and a stop mechanism interconnected to a portion of the blade proximate the tang, wherein the stop mechanism extends outward from at least one of the first side and the second side of the blade, wherein an outer surface of the stop mechanism engages a first surface of the handle when the blade is in the first extended position, and wherein the outer surface of the stop mechanism engages a second surface of the handle when the blade is in the second closed position.

In a further embodiment, the first surface of the handle is different than the second surface of the handle; the first surface of the handle is a vertical forward-most surface of the handle and the second surface of the handle is a bottom surface of the handle; and/or the stop mechanism extends outward from both the first and second sides of the blade. In some embodiments, the stop mechanism is friction fit in an aperture in the blade, the aperture in the blade has a circular shape and wherein the stop mechanism has a cylindrical shape, and the stop mechanism has a through hole that extends through the blade. In various embodiments, the folding knife further comprises a first liner, a second liner, a first scale, and a second scale, wherein the first liner, the second liner, the first scale, and the second scale are substantially parallel to one another, and wherein there is a space between the first and second liners that forms a channel for receiving the cutting edge of the blade when the blade is in the second closed position. Further, the stop mechanism extends outward from the first side of the blade a distance equal to a width of the first liner and the stop mechanism extends outward from the second side of the blade a distance equal to a width of the second liner. In some embodiments, locking mechanism is a liner lock, frame lock, compression lock, stop pin lock, or rotational wedge lock. In one embodiment, a bottom portion of the handle has a rounded shape and an outer surface of the stop mechanism has a rounded shape. In additional embodiments, the stop mechanism has a top surface substantially perpendicular to the outer surface and the top surface of the stop mechanism is substantially flat. In one embodiment, the stop mechanism has a top surface with a surface area between about 0.30 square inches and about 0.40 square inches; the stop mechanism has a top surface with a surface area between about 50 mm² and about 60 mm²; or the stop mechanism has a thickness between about 0.030 inches and about 0.125 inches. In some embodiments, the stop mechanism is positioned between about 0.10 inches and about 0.30 inches below the spine of the blade.

In one embodiment, a folding knife is provided comprising: a handle; a blade moveable from a first extended position to a second closed position and having a front end, a tang on a rear end, a spine, a cutting edge opposite the spine, first side, and a second side opposite the first side, the blade pivotally interconnected to a forward end of the handle; a locking mechanism moveable from a first locked position to a second released position; and a stop mechanism interconnected to a portion of the blade proximate the tang, wherein the stop mechanism extends outward from at least one of the first side and the second side of the blade, wherein an outer surface of the stop mechanism engages a first surface of the handle when the blade is in the first extended position or the second closed position. In a further embodiment, a top surface of the stop mechanism is substantially perpendicular to the spine of the blade.

In one embodiment, a folding knife is provided comprising: a blade moveable from a first extended position to a second closed position and having a front end, a tang on a rear end, a spine, a cutting edge opposite the spine, first side, and a second side opposite the first side, the blade pivotally interconnected to a forward end of a handle; a locking mechanism moveable from a first locked position to a second released position; a stop mechanism interconnected to a portion of the blade proximate the tang, wherein the stop mechanism extends outward from at least one of the first side and the second side of the blade, wherein an outer surface of the stop mechanism engages a first surface of the handle when the blade is in the first extended position.

In a further embodiment, when the blade is in the second closed position, the outer surface of the stop mechanism engages a second surface of the handle. In various embodiments, the stop mechanism is friction fit in an aperture in the blade. In some embodiments, the stop mechanism extends outward from both the first and second sides of the blade.

The phrases “at least one”, “one or more”, and “and/or”, as used herein, are open-ended expressions that are both conjunctive and disjunctive in operation. For example, each of the expressions “at least one of A, B, and C”, “at least one of A, B, or C”, “one or more of A, B, and C”, “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification, drawings, and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having,” and variations thereof, is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts, and the equivalents thereof, shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and Detailed Description and no limitation as to the scope of the present invention is intended by either the inclusion or non-inclusion of elements, components, etc. in this Summary of the Invention. Additional aspects of the present invention will become more readily apparent from the Detailed Description particularly when taken together with the drawings.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

FIG. 1 is a front elevation view showing some internal components of a folding knife in an open and extended position;

FIG. 2 is a rear perspective view of a folding knife, shown in an open position;

FIG. 3 is a front elevation view of the folding knife, shown in a closed position;

FIG. 4 is a front perspective view of the folding knife, shown in a closed position;

FIG. 5 is a top plan view of the folding knife, shown in an open position;

FIG. 6 is a bottom plan view of the folding knife, shown in an open position;

FIG. 7 is a bottom plan view of the folding knife, shown in a closed position;

FIG. 8 is a top plan view of the folding knife, shown in a closed position;

FIG. 9 is a rear elevation view of the folding knife, shown in an open position;

FIG. 10 is a rear elevation view of the folding knife, shown in a closed position;

FIG. 11 is a left elevation view of the folding knife, shown in an open position;

FIG. 12 is a right elevation view of the folding knife, shown in an open position;

FIG. 13 is a left elevation view of the folding knife, shown in a closed position;

FIG. 14 is a right elevation view of the folding knife, shown in a closed position;

FIG. 15 is a rear perspective view of a folding knife according to an alternative embodiment, shown in an open position;

FIG. 16 shows a portion of a knife with an alternative embodiment of the stop mechanism;

FIG. 17 shows a portion of a knife with an alternative embodiment of the stop mechanism;

FIG. 18 shows a portion of a knife with an alternative embodiment of the stop mechanism;

FIG. 19 shows a portion of a knife with an alternative embodiment of the stop mechanism;

FIG. 20 shows a portion of a knife with an alternative embodiment of the stop mechanism; and

FIG. 21 shows a portion of a knife with an alternative embodiment of the stop mechanism.

To provide further clarity to the detailed description provided herein in the associated drawings, the following list of components and associated numbering are provided as follows:

| Component No. | Component |
|---|---|
| 2 | Folding Knife |
| 6 | Blade |
| 10 | Cutting Edge (of Blade) |
| 14 | Spine (of Blade) |
| 16 | Tip (of Blade) |
| 18 | Right Side (of Blade) |
| 20 | Left Side (of Blade) |
| 22 | Tang |
| 26 | Blade Pivot Point |
| 30 | Thumb Traction Portion (of Blade) |
| 34 | Recessed Blade Portion |
| 36 | Aperture |
| 40 | Stop Mechanism/Stop Ring |
| 42 | Top Surface of Stop Mechanism |
| 44 | Inner Surface of Stop Mechanism |
| 48 | Outer Surface of Stop Mechanism |
| 50 | Handle |
| 54 | Scales |
| 58 | Liners |
| 62 | Vertical Surface of Liner (or Handle) |
| 64 | Bottom Surface of Liner (or Handle) |
| 66 | Clip |
| 70 | Lanyard Aperture |
| 74 | Choil |
| 78 | Channel (in Handle) |
| 80 | Liner Lock |

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

As described in detail below, various embodiments of the present invention include novel folding knife designs and configurations, comprising a multifunction stop mechanism and/or other features. The present invention has significant benefits across a broad spectrum of endeavors. It is the applicant's intent that this specification and the claims appended hereto be accorded a breadth in keeping with the scope and spirit of the invention being disclosed despite what might appear to be limiting language imposed by the requirements of referring to the specific examples disclosed.

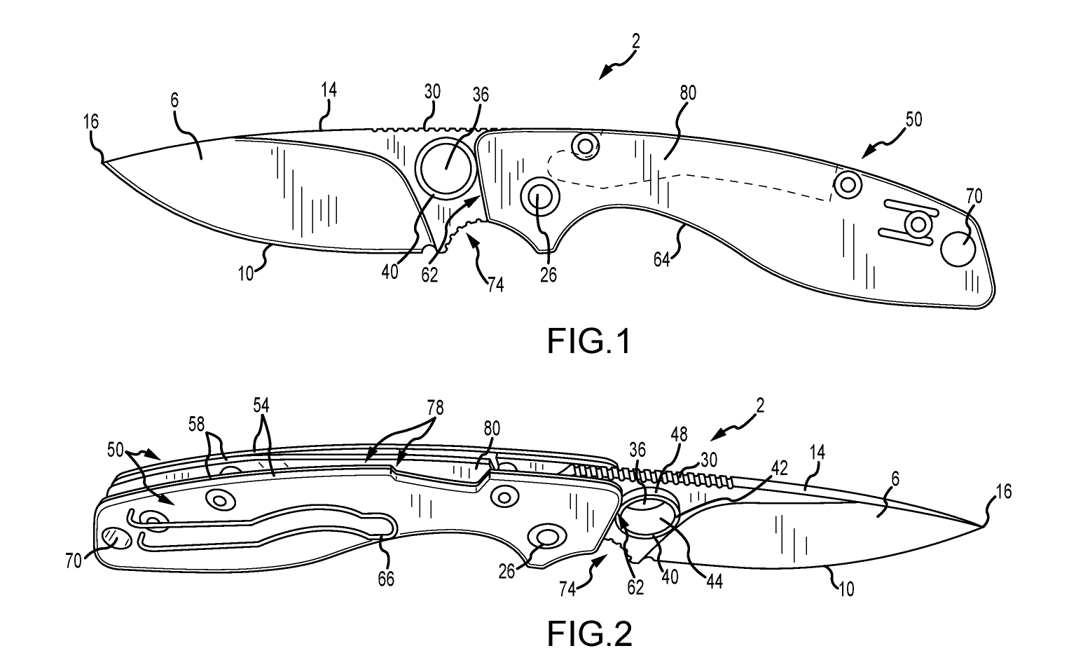

Referring now to FIGS. 1-2, the folding knife 2 is shown in the open and extended position. The folding knife 2 comprises a blade 6 with a cutting edge 10, spine 14 opposite the cutting edge 10, a thumb traction 30 on the spine 14 of the blade 6, a tip 16 on one end, and a tang 22 on the opposite end proximate the rear portion of the blade 6. The blade 6 is rotatable around a blade pivot point 26 (also called the blade rotation point, pivot pin, or pivot screw).

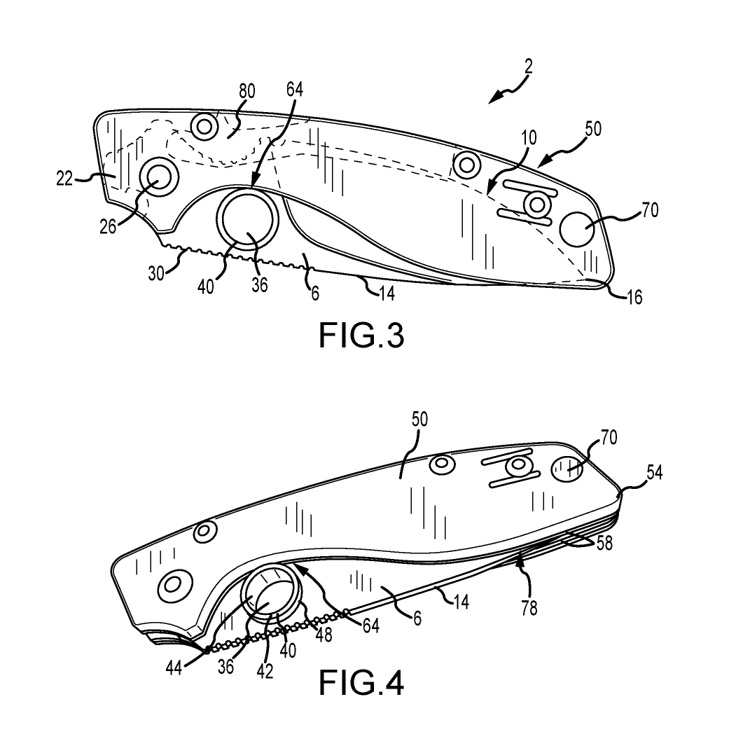

The knife 2 comprises a handle 50 with scales 54 covering the liners 58, a clip 66, a liner lock 80, a lanyard aperture 70, and a choil 74. The handle 50 has two scales 54 and two liners 58, where each scale 54 is positioned on an outer surface of each liner 58. Preferably, the liners 58 are metal, but the liners 58 can be any known material, for example, hard plastic, composite, carbon fiber, fiberglass, wood, ceramic, etc. The scales 54 can be plastic, carbon fiber, composite material, fiberglass, metal, or any other material known in the art. The liners 58 are separated by a space that forms a channel 78 in the handle 50. The channel 78 receives the blade 6 when the folding knife 2 is in a closed position (FIGS. 3 and 4).

In the embodiment shown, the knife 2 has a liner lock 80. The liner lock 80 is built into one of the liners 58 in the handle 50. However, the folding knife 2 can have any type of locking mechanism in other embodiments, for example, a frame lock, an axis lock, a ball lock, a compression lock, a rotational wedge lock, a stop pin lock, etc. The handle 50 may have a cutout to give the user access to the liner lock 80 or frame lock.

The blade 6 further comprises a stop mechanism 40 (also called a ring stop). The handle 50 or liner 58 has a vertical surface 62 proximate the forward portion of the handle 50 and a bottom surface 64. The vertical surface 62 may be the forward-most portion of the handle 50. In some embodiments, the stop mechanism 40 is positioned between about 0.05 inches and about 0.40 inches below the spine 14 of the blade 6 (as measured from the spine 14 to the outer surface (48 in other figures) of the stop mechanism 40). In a preferred embodiment, the stop mechanism 40 is positioned between about 0.10 inches and about 0.30 inches below the spine 14 of the blade 6. In a more preferred embodiment, the stop mechanism 40 is positioned between about 0.125 inches and about 0.25 inches below the spine 14 of the blade 6.

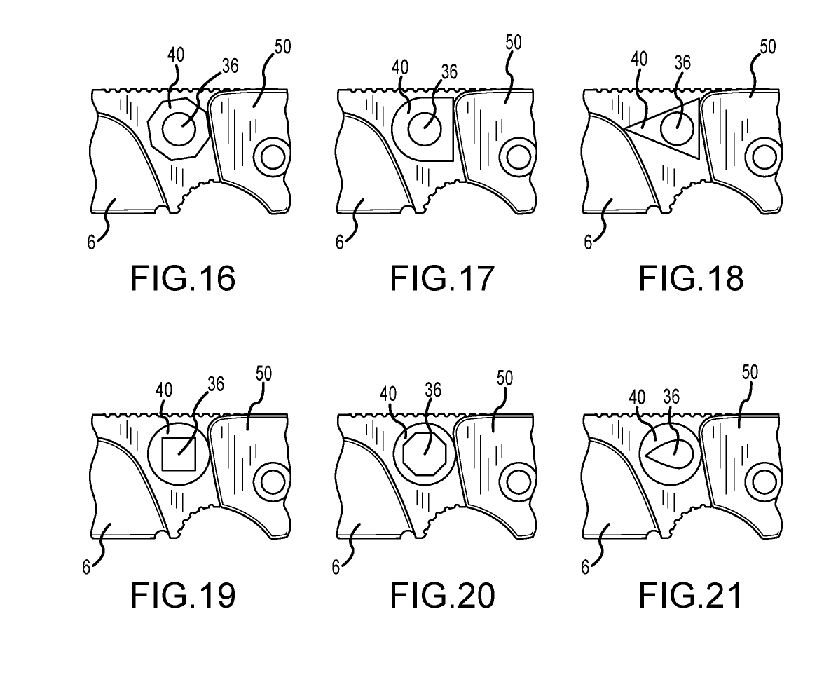

The stop mechanism 40 is positioned in an aperture 36 in the blade 6 and extends outward from either side of the blade 6. In some embodiments, the shape of the stop mechanism 40 matches the shape of the aperture 36, i.e., the stop mechanism 40 and aperture 36 are concentric. In the embodiment shown, the aperture is circular and the stop mechanism is a hollow cylinder shape. In other embodiments, the aperture 36 and stop mechanism 40 can be other shapes. In some embodiments, if the aperture 36 is another shape (e.g., oval, square, rectangular, triangular, comet-shaped, etc.), then the stop mechanism 40 will also be another shape because the stop mechanism 40 is the same shape as the aperture 36. In other embodiments, the stop mechanism 40 has a different shape than the aperture 36. See FIGS. 16-21, for example.

In still further embodiments (not shown), the aperture may not extend all the way through the stop mechanism 40. The aperture may instead be a recess, for example a concave recess. Alternatively, the recess may have a flat bottom, wavy bottom, or curved bottom.

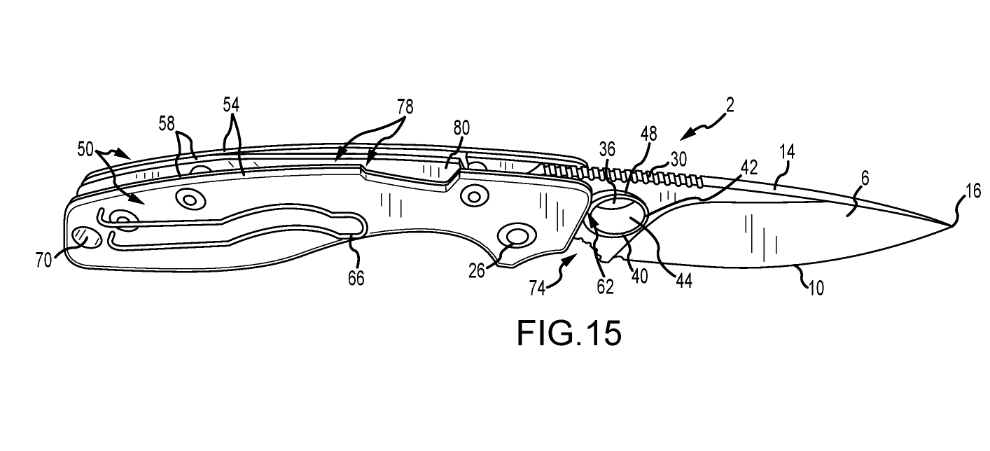

The stop mechanism 40 also has a through hole or is hollow. In other embodiments, the stop mechanism 40 is solid and does not have a through hole. The stop mechanism 40 has a top surface 42. In some embodiments, the top surface 42 of the stop mechanism 40 is substantially flat and substantially parallel to the blade 6. In various embodiments, the top surface 42 of the stop mechanism 40 is substantially perpendicular to the outer surface 48 of the stop mechanism 40. In other embodiments, the top surface 42 of the stop mechanism 40 is curved or rounded. In still further embodiments, the top surface 42 of the stop mechanism 40 is castellated or wavy. Further, the top surface 42 of the stop mechanism 40 may not be parallel to the surface of the blade 6. See FIG. 15, for example, where the top surface 42 is sloped. The top surface 42 provides added surface area for a user's thumb or fingers when the user is opening or closing the knife 2. In one embodiment, the surface area of the top surface 42 of the stop mechanism 40 is between about 0.20 inches and about 0.50 inches. In a preferred embodiment, the surface area of the top surface 42 is between about 0.30 inches and about 0.40 inches. In a more preferred embodiment, the surface area of the top surface 42 is about 0.35 inches. In another embodiment, the surface area of the top surface 42 is between about 40 mm² and about 70 mm². In a preferred embodiment, the surface area of the top surface 42 is between about 50 mm² and about 60 mm². In a more preferred embodiment, the surface area of the top surface 42 is about 54 mm². In one embodiment, the thickness of the stop mechanism 40 (as measured from the aperture 36 to the outer surface 48 when viewed from a front elevation view, i.e., FIG. 1) is between about 0.030 inches and about 0.125 inches.

When the folding knife 2 is the open position, an outer surface 48 of the stop mechanism 40 engages at least one surface of the handle 50 or liner(s) 58. In this position, the stop mechanism 40 prevents the blade 6 from over-rotating beyond the desired open position. In the embodiment shown, the outer surface 48 of the stop mechanism 40 on one side of the blade 6 engages one vertical surface 62 of the handle 50, which may be the vertical surface 62 of the scale 54 and/or liner 58, and the outer surface of the stop mechanism on the second side (not shown in FIGS. 1 and 2) of the blade 6 engages a second vertical surface of the handle 50, which may be the vertical surface of a second scale and/or liner. These vertical surfaces 62 may be the forward-most portions of the handle 50. Thus, in the embodiment shown the stop mechanism 40 has two contact points with the handle 50. In alternative embodiments, the stop mechanism 40 may only engage one surface of the handle 50. In other embodiments, the stop mechanism 40 may only extend outward from one side of the blade 6. Whereas in the embodiment shown, the stop mechanism 40 extends outward from both sides of the blade 6. When the stop mechanism 40 extends outward from both sides of the blade 6, the stop mechanism 40 can contact two vertical surfaces 62 of the handle 50, which distributes the force applied on the handle 50 at two locations. This improves the performance of the stop mechanism 40 and limits the amount of torsion experienced by the blade 6 because the force is applied to both sides the blade 6.

Referring to FIGS. 3-4, the folding knife 2 is shown in the closed position. In the closed positions, the spine 14 of the blade 6 is visible and the sharp cutting edge 10 and tip 16 of the blade 6 are safely concealed within the handle 50. As can be seen in FIGS. 3-4, when the knife 2 is in the closed position, the outer surface 48 of the stop mechanism 40 on one side of the blade 6 engages one bottom surface 64 of the handle 50, which may be the bottom surface 64 of the scale 54 and/or liner 58, and the outer surface of the stop mechanism 40 on the second side (not shown) of the blade 6 engages a second bottom surface of the handle 50, which may be the bottom surface of a second scale 54 and/or second liner 58. A portion of the bottom surface 64 of the handle 50 has a rounded shape to accommodate a user's hand and the outer surface 48 of the stop mechanism 40 has a rounded shape to abut the bottom surface 64 of the handle 50 when the knife 2 is in the closed position.

Thus, in the embodiment shown, the stop mechanism 40 has two contact points with the handle 50 when the knife 2 is in the closed position. In alternative embodiments, the stop mechanism 40 may only engage one bottom surface of the handle 50. In this position, the stop mechanism 40 prevents the blade 6 from over-rotating beyond the desired closed position and prevents the blade 6 from going too far into the channel 78 of the handle 50. By stopping the blade 6 from over-rotating into the handle 50, the stop mechanism 40 prevents the blade 6 from dulling due to hitting components (e.g., pins, screws, tubes, holes, etc.) within the handle channel 78. The stop mechanism 40 is the only component that is preventing the blade 6 from rotating further into the channel 78. Thus, no other portion of the blade 6 is abutting a portion of the handle 50.

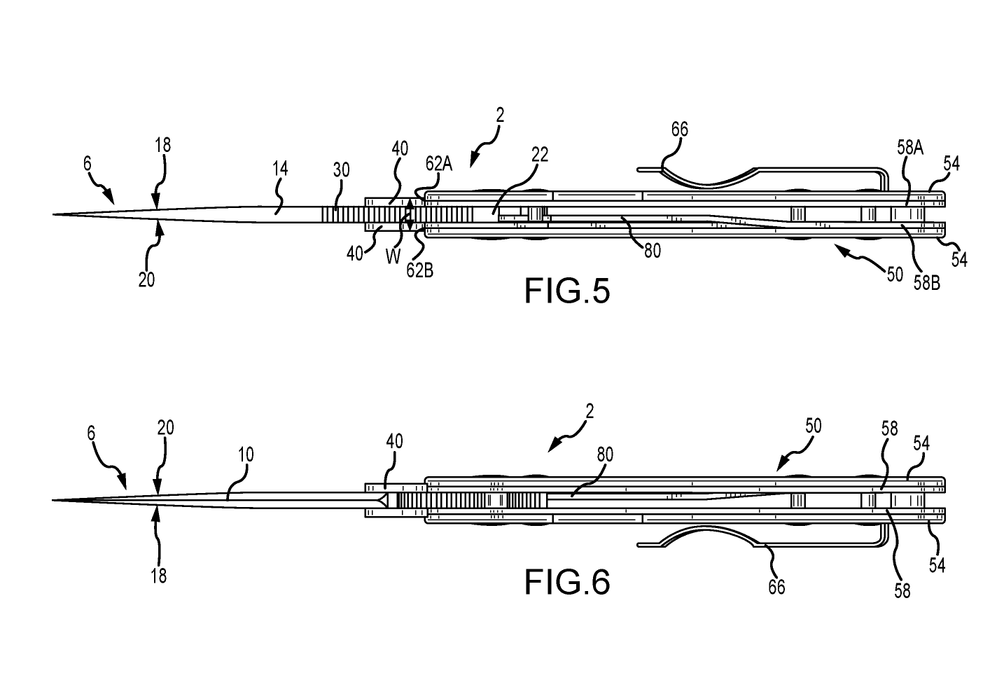

FIG. 5 is a top plan view of the folding knife 2 shown in an open position. The stop mechanism 40 can be seen extending outward from the blade 6 on either side 18, 20 of the blade 6. In other words, the stop mechanism 40 extends outward from the right side 18 of the blade 6 and extends outward from the left side 20 of the blade 6. The channel 78 in the handle 50 can also be seen in this view. Further, one can see that both sides of the stop mechanism 40 contact the handle 50 when the knife 2 is in the open position. More specifically, the outer surface of the stop mechanism 40 on one side 18 of the blade 6 contacts the vertical surface 62A of a first liner 58A and the outer surface of the stop mechanism 40 on the other side 20 of the blade 6 contacts the vertical surface 62B of a second liner 58B. In some embodiments, the stop mechanism 40 extends out from the blade 6 a distance equal to the thickness of the liner 58. In other embodiments, the stop mechanism 40 extends out from the blade 6 a distance greater than the thickness of the liner 48 such that it hits both the liner 48 and scale 54 when the blade 6 is in the open and closed positions. In still further embodiments, the stop mechanism 40 may extend out a distance greater than the thickness of the handle 50. The width W of the stop mechanism 40 can vary in various embodiments. In the embodiment shown, the width W of the stop mechanism 40 is between about 4.0 mm and about 10.0 mm. In a preferred embodiment, the width W of the stop mechanism 40 is between about 6.0 mm and about 8.0 mm. In a more preferred embodiment, the width W of the stop mechanism 40 is about 7.0 mm. Thus, the stop mechanism 40 is wider than the width of the spine 14 of the blade 6, which provides additional surface area for a user's thumb or index finger when the user is using the knife 2 and the blade 6 in the open position.

FIG. 6 is a bottom plan view of the folding knife 2 shown in an open position. Because the stop mechanism 40 extends outwardly from the blade 6 on at least one side 18, 20 of the blade 6, the stop mechanism 40 can be used by the user to open the blade 6 when the knife 2 is in the closed position. In the embodiment shown, the stop mechanism 40 extends outwardly from both sides 18, 20 of the blade 6, which allows the user to use either thumb (right or left) to open the knife 2 or use his thumb and a finger (i.e., pinch the stop mechanism 40) to open the knife 2. Thus, the stop mechanism 40 provides traction and something for the user to grab when opening the folding knife 2. Accordingly, the stop mechanism 40 acts similar to a thumb stud when assisting the user in opening the knife 2.

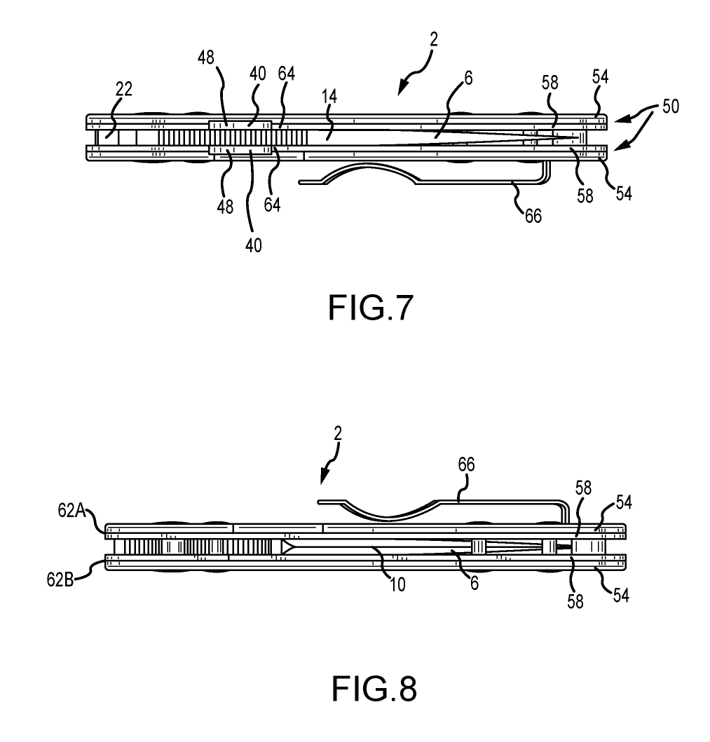

FIG. 7 is a bottom plan view of the folding knife 2 shown in a closed position. The outer surfaces 48 of the stop mechanism 40 contact the bottom surfaces 64 of the handle 50, which may be the liners 58 alone or the liners 58 and the scales 54. The spine 14 and the upper surface of the tang 22 of the blade 6 can be seen in this view.

FIG. 8 is a top plan view of the folding knife 2 shown in a closed position. Here, the cutting edge 10 of the blade 6 is visible. Further, the liners 58 and scales 54 of the handle can be seen. One end of the handle has the two vertical surfaces 62A, 62B for contacting the outer surface of the stop mechanism when the blade 6 is in the open position.

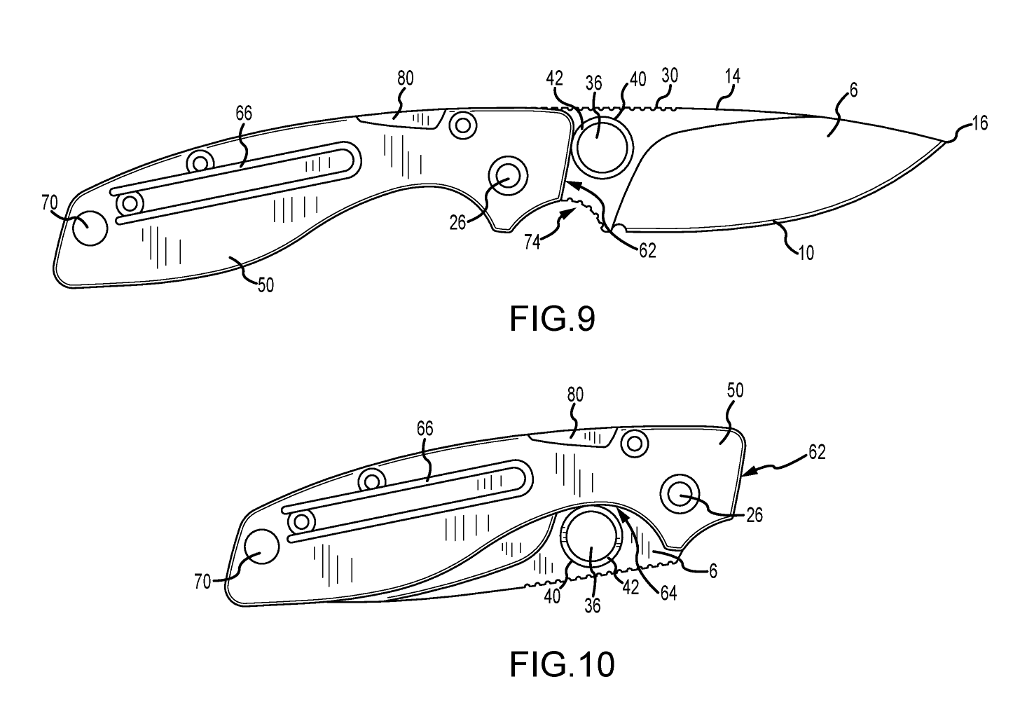

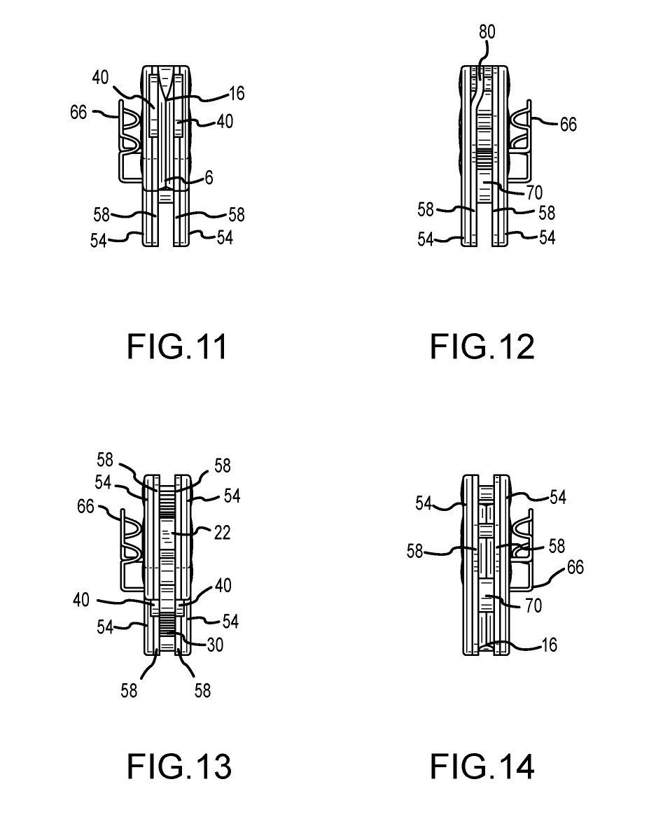

FIG. 9-14 are additional views of the folding knife 2. Specifically, FIG. 9 is a rear elevation view of the folding knife 2 shown in an open position. FIG. 10 is a rear elevation view of the folding knife 2 shown in a closed position. FIG. 11 is a left elevation view of the folding knife 2 shown in an open position. FIG. 12 is a right elevation view of the folding knife 2 shown in an open position. FIG. 13 is a left elevation view of the folding knife 2 shown in a closed position. FIG. 14 is a right elevation view of the folding knife 2 shown in a closed position. The component numbers used in these figures are the same as those in FIGS. 1-8. Accordingly, duplicative description will not be included here. See the descriptions above for an explanation of the components shows in FIGS. 9-14.

FIG. 15 is an alternative embodiment of the folding knife 2 and stop mechanism 40. Here, the stop mechanism 40 is tapered such that the width it extends out from the blade 6 varies along the stop mechanism 40. For example, in the embodiment shown, the width of the stop mechanism 40 is greater proximate the rear portion of the blade 6 and is less proximate the forward portion of the blade 6. However, in other embodiments, the stop mechanism width could vary in the opposite direction—wider proximate the forward portion of the blade 6—or could be thicker at the top and/or bottom of the blade 6. If the stop mechanism top surface 42 is angled or sloped relative to the blade 6 (as shown in FIG. 15), then it may be easier for the user to grab part of the stop mechanism 40 when opening or closing the blade 6.

FIGS. 16-21 show alternative embodiments of the stop mechanism 40. Only a portion of the knife blade 6 and handle 50 are shown in these figures. As shown, the stop mechanism 40 can be a variety of shapes: octagon (FIG. 16), “D” shape (FIG. 17), triangle (FIG. 18), circle (FIGS. 19-21), and any other shape known or desired. Further, the aperture 36 can be a variety of shapes and the aperture 36 shape does not have to match the stop mechanism 40 shape. For example, the aperture can be a circle (FIGS. 16-18), a square (FIG. 19), an octagon (FIG. 20), a comet or tear drop (FIG. 21), or any other shape known or desired.

In some embodiments, the stop mechanism is a friction-fit press-in component that is pressed into the aperture in the blade. Thus, the stop mechanism is one solid piece that extends through the aperture in the blade such that it extends outwardly from one or both sides of the blade. Alternatively, the stop mechanism may be glued or bonded into the aperture in the blade. In other embodiments, the stop mechanism may be molded or cast with the blade. In other embodiments, the stop mechanism is securing using heat shrinking. For example, a cutoff tool cuts a welding band (groove) into the outer surface of the stop mechanism. The stop mechanism is then cooled in liquid nitrogen (or another cooling method) and then put into the aperture. The stop mechanism is then heated to expand the stop mechanism such that the aperture is securely positioned in the welding band (groove). In still further embodiments, the stop mechanism can be brazed or welded in the blade. Alternatively, the stop mechanism can be interconnected using fasteners such as screws or key features.

The blade is typically metal, but can be any known material such as ceramic, fiberglass, or plastic. The stop mechanism is typically the same material as the blade and, thus, is also metal. However, the stop mechanism can be any other material known and used in the art. However, the stop mechanism can be a material that is different from the blade. For example, the blade may be one type of metal and the stop mechanism may be a different type of metal.

The foregoing description of the present invention has been presented for illustration and description purposes. However, the description is not intended to limit the invention to only the forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Consequently, variations and modifications commensurate with the above teachings and skill and knowledge of the relevant art are within the scope of the present invention. The embodiments described herein above are further intended to explain best modes of practicing the invention and to enable others skilled in the art to utilize the invention in such a manner, or include other embodiments with various modifications as required by the particular application(s) or use(s) of the present invention. Thus, it is intended that the claims be construed to include alternative embodiments to the extent permitted by the prior art.

What is claimed is:

1. A folding knife comprising:
a handle;
a blade moveable from a first extended position to a second closed position and having a front end, a tang on a rear end, a spine, a cutting edge opposite the spine, first side, and a second side opposite the first side, the blade pivotally interconnected to a forward end of the handle;
a locking mechanism moveable from a first locked position to a second released position; and
a stop mechanism interconnected to a portion of the blade proximate the tang, wherein the stop mechanism extends outward from at least one of the first side and the second side of the blade, wherein an outer surface of the stop mechanism engages a first surface of the handle when the blade is in the first extended position, and wherein the outer surface of the stop mechanism engages a second surface of the handle when the blade is in the second closed position.

2. The folding knife of claim 1, wherein the first surface of the handle is different than the second surface of the handle.

3. The folding knife of claim 1, wherein the first surface of the handle is a vertical forward-most surface of the handle and the second surface of the handle is a bottom surface of the handle.

4. The folding knife of claim 1, wherein the stop mechanism is positioned in an aperture in the blade, and wherein the aperture in the blade has a circular shape and wherein the stop mechanism has a cylindrical shape.

5. The folding knife of claim 4, wherein the stop mechanism has a through hole that extends through the blade.

6. The folding knife of claim 1, wherein the stop mechanism extends outward from both the first and second sides of the blade.

7. The folding knife of claim 1, further comprising a first liner, a second liner, a first scale, and a second scale, and wherein the first liner, the second liner, the first scale, and the second scale are substantially parallel to one another, and wherein there is a space between the first and second liners that forms a channel for receiving the cutting edge of the blade when the blade is in the second closed position.

8. The folding knife of claim 7, wherein the stop mechanism extends outward from the first side of the blade a distance equal to a width of the first liner.

9. The folding knife of claim 8, wherein the stop mechanism extends outward from the second side of the blade a distance equal to a width of the second liner.

10. The folding knife of claim 1, wherein locking mechanism is a liner lock.

11. The folding knife of claim 1, wherein locking mechanism is a frame lock, compression lock, stop pin lock, or rotational wedge lock.

12. The folding knife of claim 1, wherein a bottom portion of the handle has a rounded shape and an outer surface of the stop mechanism has a rounded shape.

13. The folding knife of claim 1, wherein the stop mechanism has a top surface substantially perpendicular to the outer surface.

14. The folding knife of claim 13, wherein the top surface of the stop mechanism is substantially flat.

15. The folding knife of claim 1, wherein the stop mechanism has a top surface with a surface area between about 0.30 square inches and about 0.40 square inches.

16. The folding knife of claim 1, wherein the stop mechanism has a top surface with a surface area between about 50 mm² and about 60 mm².

17. The folding knife of claim 1, wherein the stop mechanism has a thickness between about 0.030 inches and about 0.125 inches.

18. The folding knife of claim 1, wherein the stop mechanism is positioned between about 0.10 inches and about 0.30 inches below the spine of the blade.

19. A folding knife comprising:
a handle;
a blade moveable from a first extended position to a second closed position and having a front end, a tang on a rear end, a spine, a cutting edge opposite the spine, first side, and a second side opposite the first side, the blade pivotally interconnected to a forward end of the handle;
a locking mechanism moveable from a first locked position to a second released position; and
a stop mechanism interconnected to a portion of the blade proximate the tang, wherein the stop mechanism extends outward from at least one of the first side and the second side of the blade, wherein an outer surface of the stop mechanism engages a first surface of the handle when the blade is in the first extended position or the second closed position.

20. The folding knife of claim 19, wherein a top surface of the stop mechanism is substantially perpendicular to the spine of the blade.
